(19) United States
(12) Patent Application Publication
(10) Pub. No.: US 2021/0185119 A1
(43) Pub. Date: Jun. 17, 2021

(54) A Decentralized Load-Balancing Method for Resource/Traffic Distribution

(71) Applicants: Fereydoun FARRAHI MOGHADDAM, Brossard (CA); Wubin LI, Kirkland, CA (US)

(72) Inventors: Fereydoun FARRAHI MOGHADDAM, Brossard (CA); Wubin LI, Kirkland, CA (US)

(73) Assignee: TELEFONAKTIEBOLAGET LM ERICSSON (PUBL), Stockholm (SE)

(21) Appl. No.: 17/272,267

(22) PCT Filed: Sep. 4, 2018
(86) PCT No.: PCT/IB2018/056745

§ 371 Date: Feb. 26, 2021

(51) Int. Cl. H04L 29/08

(52) U.S. Cl. CPC H04L 67/1023; H04L 67/1008

(57) ABSTRACT

There is provided a method in a client node to perform a distribution of a received object to a distributed system having a set of server nodes. The method comprises: obtaining an identity of the received object; determining a server node among the set of server nodes to send the object to, based on one or more policies; and sending the object to the determined server node. Furthermore, determining the server node comprises: generating a plurality of candidates using a function that pairs the identity of the object with each of the server node in the set of server nodes; selecting a candidate that meets the one or more policies among the sorted plurality of candidates, the determined server node corresponding to the server node associated with the selected candidate. A client node for carrying out this method is also provided.

### TECHNICAL FIELD

The present disclosure relates to distributing traffic or resources in networks; and, in particular, to systems and methods for distributing traffic or resources in the networks without the use of a central load balancer.

### BACKGROUND

Resource/Traffic distribution is a common task in networks and cloud environments. Typical examples include:

1) VM (Virtual Machine)/container distribution across multiple servers. The main goal is to decide on which server to run the VM/container in order to achieve e.g., optimal resource utilization, or service level agreement (SLA) assurance.

2) Storage object distribution across multiple servers/devices. Typically, the main goal is to distribute the data objects evenly for the sake of e.g., high availability through replication, load-balancing, and scalability. One example of Software Defined Storage (SDS) is the Ceph SDS solution. Ceph using a unique load balancing algorithm is referred to as CRUSH. The CRUCH method eliminates the need for a central load balancer. Details regarding CRUSH can be found in Weil, Sage A., et al. “Ceph: A Scalable, High-Performance Distributed File System,” Proceedings of the 7th symposium on Operating systems design and implementation, USENIX Association, Nov. 6-8, 2006 and Weil, Sage A., et al. “CRUSH: Controlled, Scalable, Decentralized Placement of Replicated Data,” Proceedings of the 2006 ACM/IEEE Conference on Supercomputing, ACM, Nov. 11-17, 2006.

3) Traffic distribution, e.g., round-robin for load balancing purpose.

Typically, there are common challenges involved in a distribution task such as:

a) Consistency: with the same input the same output is expected and if the input changes slightly the output is expected to change slightly (minimum), there should not have a complete reshuffle.

b) Scaling and failure handling: when the numbers of bins/slots are dynamic due to scaling or failure, it is much harder to provide a uniform distribution across the bins/slots while the distribution should still be consistent.

c) Weighted distribution: sometimes it is desired that some bins/slots proportionally receive higher or lower traffic/resource.

d) Policy-based distribution: often a simple uniform distribution is not enough, and the distribution must be done based on some criteria defined by policies.

e) Catastrophic reshuffling: almost all state of the art methodologies has a breaking point that the system will not be optimized beyond that point and a new optimization is necessary which will lead to a partial or total reshuffling of the resources.

f) Decentralization: being centralized has its bottleneck problems and being decentralized introduces the synchronization problem.

g) Indexing: Storing the index will impact the scalability, therefore algorithmically reproducible indexes are favored for highly scalable systems. However, there is a high computation and time complexity tag associated with them.

h) Size of the problem: many of the state of the art solutions must have the number of bins/slots as a parameter or at least a maximum number of bins/slots, this constraint reduces the flexibility of the system.

Therefore, there is still a need for an improved non-centralized load balancing technique for distributing resource/traffic in servers.

### SUMMARY

The embodiments of the present disclosure provide an improved non-centralized load balancing technique for distributing resource/traffic in servers, that solve all the challenges as described above.

According to one aspect, there is provided a method in a client node to perform a distribution of a received object to a distributed system having a set of server nodes. The method comprises: obtaining an identity of the received object; determining a server node among the set of server nodes to send the object to, based on one or more policies; and sending the object to the determined server node. Furthermore, determining the server node may comprise: generating a plurality of candidates using a function that pairs the identity of the object with each of the server node in the set of server nodes; selecting a candidate that meets the one or more policies among the plurality of candidates, the determined server node corresponding to the server node associated with the selected candidate.

According to another aspect, some embodiments include a client node configured, or operable, to perform one or more of the client node's functionalities (e.g. actions, operations, steps, etc.) as described herein.

In some embodiments, the client node may comprise one or more communication interfaces configured to communicate with one or more other radio nodes and/or with one or more network nodes, and processing circuitry operatively connected to the communication interface, the processing circuitry being configured to perform one or more of the client node's functionalities as described herein. In some embodiments, the processing circuitry may comprise at least one processor and at least one memory storing instructions which, upon being executed by the processor, configure the at least one processor to perform one or more of the client node's functionalities as described herein.

In some embodiments, the client node may comprise one or more functional modules configured to perform one or more of the client node's functionalities as described herein.

According to another aspect, some embodiments include a non-transitory computer-readable medium storing a computer program product comprising instructions which, upon being executed by processing circuitry (e.g., at least one processor) of the client node, configure the processing circuitry to perform one or more of the client node's functionalities as described herein.

The embodiments may provide the following advantages:

1) Easy scale-out/scale-in and failure handling as the embodiments are not sensitive to the number of resources/bins.

2) Low computation overhead with comparable time complexity.

3) Easy to implement, debug, and forensic (if for whatever reasons the actions of the load balancer are required to be audited, it is easier to perform a root cause analysis than for example a random function or any other non-deterministic function).

4) Non-centralized:
a. The distribution is deterministically calculable by all entities, such as all clients and storage nodes. For example, when a new storage node is added to the system, no clients are involved, and the storage nodes need to load balance between themselves. Another example for an entity could be a third party auditor or logger or evaluator. There is no need to refer to a store (e.g. a database)).

5) Built-in policy driven
a. Support weights

This summary is not an extensive overview of all contemplated embodiments, and is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a distributed storage system in accordance with some embodiments of the present disclosure;

FIG. 2 illustrates the operation of a client node to perform a distribution operation for a received object in accordance with some embodiments of the present disclosure;

FIG. 3 is a flow chart that illustrates a method for a client node to perform step 220 of FIG. 2 in more detail according to some embodiments of the present disclosure;

FIG. 4 illustrates one example of distributing an object among a set of server nodes in accordance with some embodiments of the present disclosure;

FIG. 5 illustrates a flow chart that illustrates a method for a client node to perform step 220 of FIG. 2 in more detail in accordance with some embodiments of the present disclosure;

FIG. 6 illustrates one example of distributing an object among a set of server nodes in accordance with some embodiments of the present disclosure;

FIGS. 7 and 8 illustrate example embodiments of a client node; and

FIGS. 9 and 10 illustrate example embodiments of a server node.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

As mentioned earlier, the existing solutions are either too complicated to implement or they lack sufficient features/characteristics to cover a wide range of use cases.

More specifically, the existing solutions can be divided into two main categories:

1) Centralized solutions. The main drawback of those solutions is that they usually rely on a centralized location either for storing the distributed traffic or for algorithm execution, the centralized location indicating potential issues of scalability.

2) Decentralized solutions. Typical examples include the CRUSH algorithm in Ceph. A comprehensive research on these algorithms can be found in reference [1]. The CRUSH algorithm is quite complex. The embodiments in this disclosure has multiple advantages over CRUSH.

Embodiments of the disclosure allow to consistently distribute resource/traffic across multiple destinations/servers. There are many algorithms in different domains that are designed to achieve the same goal, however, the present embodiments can distribute the resource/traffic based on policy and weight even without knowing the number of bins/servers and can still keep the time complexity in a comparable level as the algorithms of comparable level that know the number of servers. The present embodiments also do not have a catastrophic reshuffling point.

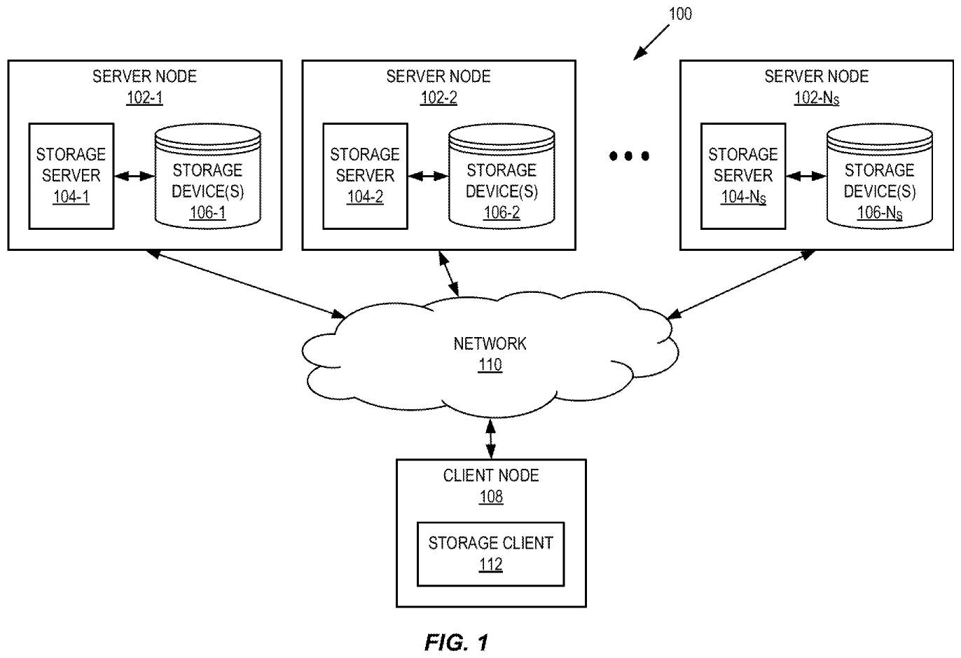

FIG. 1 illustrates one example of a distributed system 100 in accordance with some embodiments of the present disclosure. The distributed system 100 is preferably a cloud-based system. As illustrated, the distributed system 100 includes a number (Ns) of server nodes 102-1 through 102-Ns, which are generally referred to herein as server nodes 102. Note that the server nodes 102-1 through 102-Ns are also referred to herein as a “cluster” or “cluster of server nodes.” The server nodes 102 are physical nodes comprising hardware (e.g., processor(s), memory, etc.) and software. In this particular example, the server nodes 102-1 through 102-Ns can include storage servers 104-1 through 104-Ns and storage devices 106-1 through 106-Ns, which are generally referred to herein as storage servers 104 and storage devices 106. The storage servers 104 are preferably implemented in software and operate to provide the functionality of the server nodes 102 described herein. The storage devices 106 are physical storage devices such as, e.g., hard drives. The server nodes 102 may comprise other components as well.

The distributed system 100 also includes a client node 108 that communicates with the server nodes 102 via a network 110 (e.g., the Internet). While only one client node 108 is illustrated for clarity and ease of discussion, the distributed storage system 100 typically includes many client nodes 108. The client node 108 is a physical node (e.g., a personal computer, a laptop computer, a smart phone, a tablet, or the like). The client node 108 includes a client 112, which is preferably implemented in software. The client 112 operates to provide the functionality of the client node 108 described herein.

The server nodes 102 operate to receive and store a number of packets (or traffic) or resources, from the client node 108. It should be noted that the server nodes 102 may be referred to as a slots or bins. Also, in general, the packets will be referred to as objects. For each object, several packets may travel between the client node 108 and the server node 102, for example.

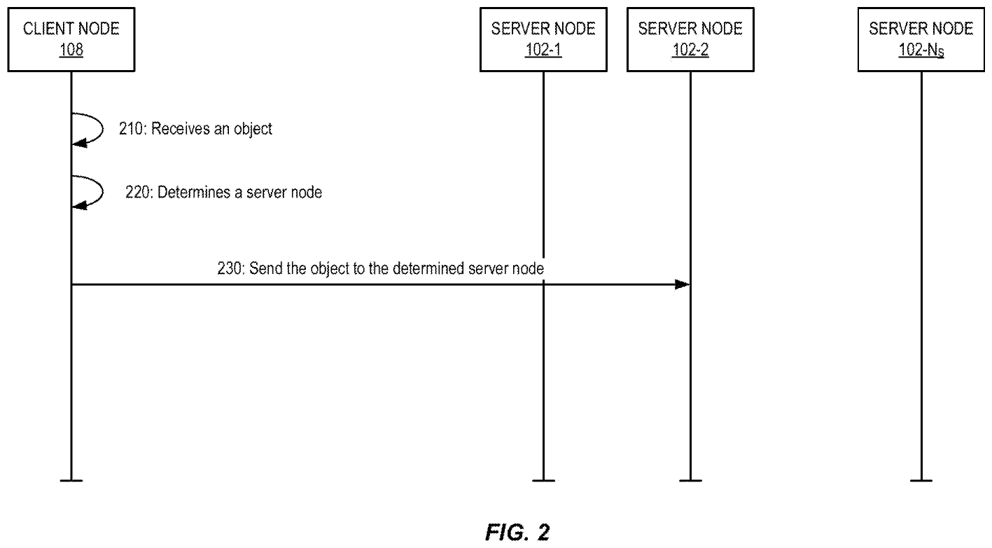

FIG. 2 illustrates the method or operations 200 of the client node 108 to perform a distribution of resources/traffic to a plurality of server nodes such as 102.

In step 210, the client node 108 receives a packet of data/traffic or a resource, which will be referred to as an object.

In step 220, the client node 108 determines a destination server node for sending the object to, according to embodiments of the disclosure. The details of step 220 are provided below. However, in general, the client node 108, and in particular the client 112, generates at least a list of values associated with the object and each of the server nodes 102.

In step 230, the client node 108 sends the object to the determined destination server node, for example server node 102-2 as illustrated in FIG. 2.

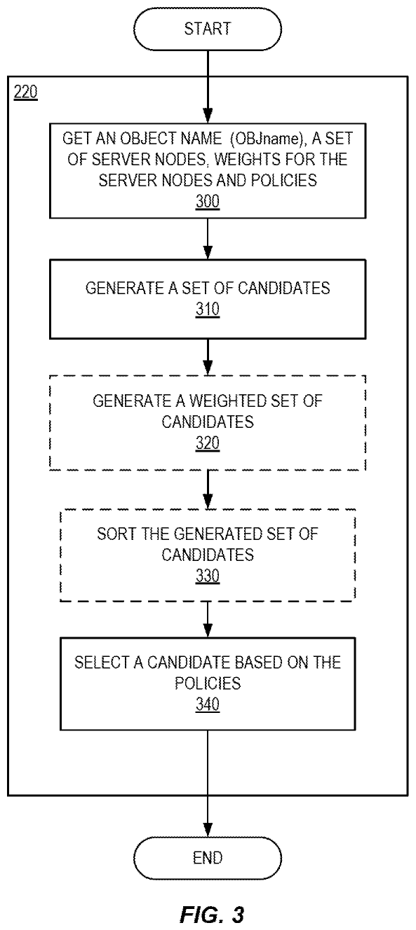

FIG. 3 is a flow chart that illustrates a method for the client node 108 to perform step 220 of FIG. 2 in more detail according to some embodiments of the present disclosure.

As illustrated, in order to determine the destination server node 102 for sending the object to, the client node 108 gets (i.e., obtains) the names or identities of a set of server nodes 102 (1 to Ns) that exist or are suitable to receive the object, in the distributed system 100, an object name (OBJname) of the received object for the distribution operation, one or more policies, and one or more weights (optional) (block 300). The object name could be any names chosen according to any rules or conventions as long as it is unique.

The weights may be used to change the distribution of the traffic. As such, the traffic/resources may be distributed based on weights. For example, if there are two slots, one is associated with weight of 1 and the other is associated with weight 0.5, then it means that the second slot can receive twice of the traffic compared to the first slot.

The one or more policies may be used to define some criteria that need to be met before a server node (bin/slot) is assigned to a resource/traffic. For example, if there are 3 slots and 2 of them met a criterion for a specific traffic, then, the specific traffic will be distributed only to the 2 slots, based on the weights of the 2 slots. The third slot is unqualified for this specific traffic. It should be noted that the one or more policies have a higher priority than the weights. As such, they can override the choice of a server node determined based on the weights.

In step 310, the client node 108 generates a set of candidates using a function that pairs the object name with each of the server nodes in the set of server nodes 102. For example, the client node 108 can use a hash function as the pairing function. The hash function is a hashing function that takes two parameters as the input and produces a pseudo random number ranging from zero to one ([0, 1]). Given the same input, it guarantees that the same output is produced. An example for the Hash Function is h(A,B)=SHA256(A+“#”+B)/2\hat{ }256. It should be noted that other functions may be used, as long as these functions have the properties of obtaining the same output given the same input.

Using the hash function, the two parameters that are paired are 1) the name/identity (ID) of the object (OBJname), and 2) the name/ID of a server node in the set of server nodes 102.

Therefore, the client node 108 can generate the set of candidates by applying the following function:

For each server node [i], where i=1 to Ns, the client node 108 calculates a candidate denoted V[i]: V[i]=HashFunction (OBJname, server node [i]).

If weights have been configured or obtained for the client node 108 to use, then, the client node 108 will generate a weighted set of candidates based on the set of candidates and the weights (step 320). For example, the weights can be denoted as W[i] associated with a server node [i], then the weighted set of candidates denoted as U[i] is U[i]=(1−W[i]) V[i] or U[i]=W[i]V[i], for i=1 to Ns. This step may be optional.

In step 330, the client node 108 sorts the set of candidates generated in step 310 or sorts the weighted set of candidates generated in step 320, according to an order. This step may be optional.

The set of candidates can be sorted according to an ascending order (from the minimum value to the maximum value) or descending order (from the maximum value to the minimum value) or any other orders as will be appreciated by a skilled person in the art. If weights are applied to the set of candidates, then the set of weighted candidates can be also sorted according to an ascending, descending order or any other orders. If the set of weighted candidates is sorted according to the ascending order (a maximum value is used to select a candidate for example), then the weighted set of candidates is given by: U[i]=W[i]V[i]. If the set of weighted candidates is sorted according to the descending order (a minimum value is used to select a candidate for example), then the weighted set of candidates is given by: U[i]=(1−W[i])V[i].

In step 340, the client node 108 selects a candidate from the sorted set of candidates that meets the one or more policies that were configured or obtained in step 300. For example, the candidate with the minimum value can be selected. This means that the server node associated with this candidate is the destination server node determined to receive the object OBJname.

Then, in step 230 (of FIG. 2), the client node 108 can send the object to the determined server node (i.e. the server node corresponding to the selected candidate in step 340).

In some embodiments, the one or more policies can have a higher priority than the weight applied to the plurality of candidates for determining a server node.

In some embodiments, the pairing function can be independent from the number of server nodes in the set of server nodes.

In some embodiments, the candidates in the plurality of candidates are independent from each other.

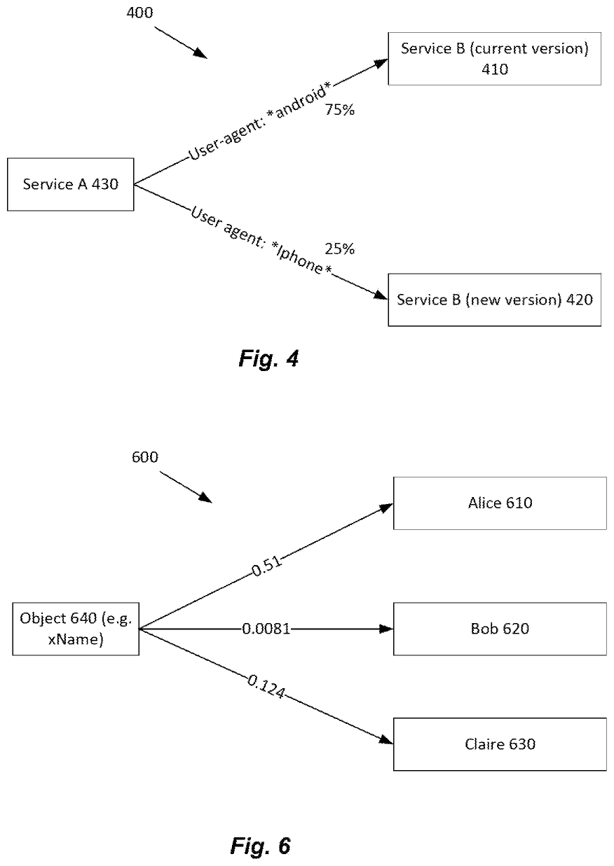

Now, turning to FIG. 4, an example 400 of a use case of method 200 will be described.

Let's suppose that a new version 410 of a service B needs to be tested before it can fully replace the current version 420. To avoid any potential issues, only 25% of the traffic coming from the upstream (Service A) 430 is to be allocated/distributed to the new version 410. Meanwhile, traffic with the same value within a specific tag needs to be handled by the same version. For example, all traffic with ‘IPhone’ in the tag ‘User-agent’ needs to go to the current version 410 or the new version 420. There can be other tag values, such as ‘Firefox’, ‘Chrome’, etc.

In order to distribute the traffic correctly based on the policies (e.g. traffic with the same value within a specific tag needs to be handled by the same version), and weights (e.g. only 25% of the traffic from service A goes to the new version 420 of service B), steps 300 to 340 of FIG. 3 can be performed by the client node 108 as follows:

Step 310: V[i]=hashfunction (tag Value, service Version [i]) where i=new version 410 and current version 420.

Step 320: U[i]=(1−W[i])*V[i] or U[i]=W[i]V[i].

Following the method of FIG. 3, for each packet, a set of sorted candidates U is generated. Normally, without any policies, the top candidates in the sorted set of U[i] will be selected as the destination server nodes, which takes into consideration the weights. For example, if 100 packets are considered, in their respective set of sorted candidates U[i], there will be approximately 25 times that the new version 420 appear as the top candidates and 75 times that the current version 410 appear as the top candidates. However, if a packet is tagged with “Iphone”, and the current version 410 is the top candidate, the current version 410 will not be selected because the current version 410 does not comply with the policies. Then, the method will proceed to the next candidate in the list (new version 420). Since the new version 420 complies with the policies, it will be chosen.

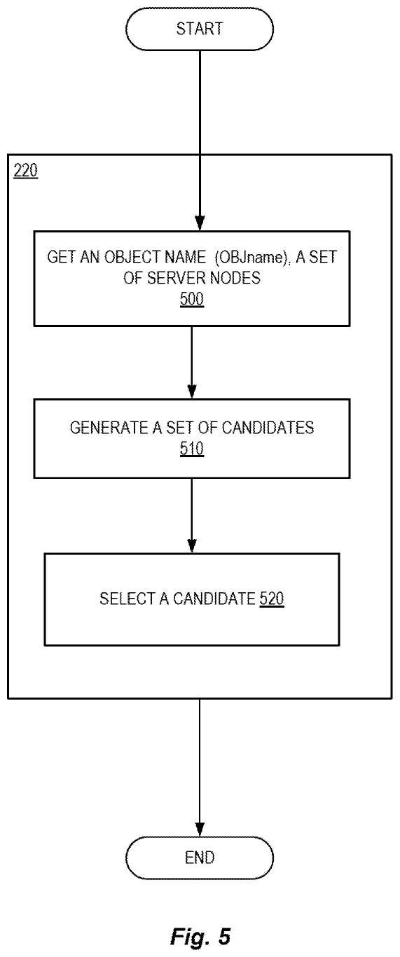

FIG. 5 illustrates a specific case of step 220, where no weights have been configured and no policies are defined. As such, FIG. 5 illustrates an even or uniform distribution of traffic among the set of server nodes. In this case, the parameter for the weights can be given by W=1 if the weighted set of candidates is defined as follows: U[i]=W[i]V[i]. The weights could be set to W=0.5, if the weighted set of candidates is defined as follows: (1−W[i])*V[i]).

More specifically, in step 500, the client node 108 gets or obtains the object name (OBJname) of the received object and the identities of the set of server nodes 102.

In step 510, the client node 108 generates a set of candidates based in general on the object and set of server nodes and more specifically based on the name of the object (OBJname) and the identities of the set of server nodes 102. For example, the client node 108 can use a function that pairs the object with each of the server nodes to generate the set of candidates. More specifically, the client node 108 can use the hash function that takes as input the object name and the identity of the server nodes. As such, the set of candidates V[i] is given by V[i]=HashFunction (OBJname, server[i]).

In step 520, the client node 108 selects a candidate from the set of candidates. The selection can be based on the minimum value or maximum value of the hashing result. To do so, the client node 108 can sort the set of candidates first.

In step 230, the client node 108 sends the object to the server node associated with the selected candidate (minimum or maximum value).

FIG. 6 illustrates an example use case 600 of the method 200 with steps 500 to 520.

For example, in this case, there are 3 server nodes Alice 610, Bob 620 and Claire 630. The client node 108 receives an object 640, having xNAme as the object name. It also receives the name of the 3 server nodes e.g. Alice, Bob and Claire.

Then, the client node 108 calculates the set of candidates based on the pair (object name and server node name) using the hashing function:

V[1]=HashFunction (xName, Alice)=0.51

V[2]=HashFunction (xName, Bob)=0.0081

V[3]=HashFunction (xName, Claire)=0.124

Then, the client node 108 selects a candidate, that has the minimum value (from the hashing result), for example. Bob 620 has the minimum value of 0.0081, as such, the server node Bob 620 is selected as the destination server node. The client node 108 sends the object 640 to the server node Bob 620. In some embodiments, if the maximum value is used for selecting a candidate, then, Alice 610 would be selected for receiving the object 640.

It should be noted that each candidate from the set of candidates is independent from each other. Also, it should be noted that the pairing function (e.g. hash function) does not depend on the number of servers, as such, there is no catastrophic reshuffling. Furthermore, the hash function has a time complexity of order of Log N. As such, the embodiments are less complex than the CRUSH algorithm, for example.

Furthermore, it should be appreciated by a person skilled in the art that the method of FIGS. 2 and 3 could be generalized to multiple dimensions and multiple criteria. For example, the one or more policies could include further criteria such as Quality of Service (QoS) and Quality of Experience (QoE) requirements. In this case, the method of FIGS. 2 and 3 would require a multi-dimension pairing function, a multi-dimension weighting function and a multi-dimension sorting function.

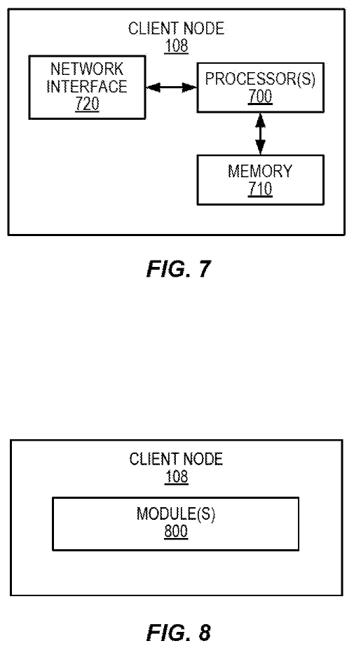

FIG. 7 is a schematic block diagram of the client node 108 according to some embodiments of the present disclosure. As illustrated, the client node 108 includes one or more processors 700 (e.g., Central Processing Units (CPUs), Application Specific Integrated Circuits (ASICs), Field Programmable Gate Arrays (FPGAs), and/or the like), memory 710, and a network interface 720. In some embodiments, the functionality of the client node 108 described above may be fully or partially implemented in software (e.g. the client 112) that is, e.g., stored in the memory 710 and executed by the processor(s) 700.

In some embodiments, a computer program including instructions which, when executed by at least one processor, causes the at least one processor to carry out the functionality of the client node 108 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as memory).

FIG. 8 is a schematic block diagram of the client node 108 according to some other embodiments of the present disclosure. The client node 108 includes one or more modules 800, each of which is implemented in software. The module(s) 800 provide the functionality of the client node 108 described herein. For example, the modules 800 may include a receiving module, a determining module and a sending module. For example, the receiving module is operable to perform step 210 of method 200 in Figure. The determining module is operable to perform at least step 220 of FIGS. 2, 3 and 5 and a sending module operable to perform step 230 of FIG. 2.

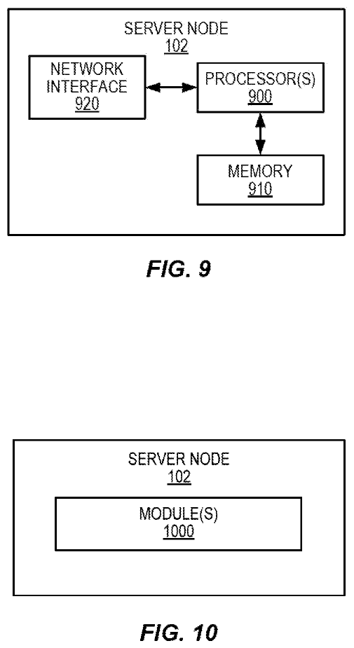

It should be noted that in the case the server nodes can perform load balancing among themselves, the server nodes 102 can act as client nodes for load balancing. As such, the server nodes can perform the methods 200 of FIG. 2, 300 of FIG. 3 or 500 of FIG. 5. FIG. 9 is a schematic block diagram of the server node 102 according to some embodiments of the present disclosure. As illustrated, the server node 102 includes one or more processors 900 (e.g., CPUs, ASICs, FPGAs, and/or the like), memory 910, and a network interface 920. In some embodiments, the functionality of the server node 102 described above may be fully or partially implemented in software (e.g., the storage server 104) that is, e.g., stored in the memory 910 and executed by the processor(s) 900.

In some embodiments, a computer program including instructions which, when executed by at least one processor, causes the at least one processor to carry out the functionality of the server node 102 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the server node 102 according to some other embodiments of the present disclosure. The server node 102 includes one or more modules 1000, each of which is implemented in software. The module(s) 1000 provide the functionality of the server node 102 described herein. For example, the modules 1000 may include a receiving module, a determining module and a sending module. For example, the receiving module is operable to perform step 210 of method 200 in Figure. The determining module is operable to perform at least step 220 of FIGS. 2, 3 and 5 and a sending module operable to perform step 230 of FIG. 2.

Those skilled in the art will recognize improvements and modifications to the embodiments of the present disclosure. All such improvements and modifications are considered within the scope of the concepts disclosed herein.

1. A method in a client node to perform a distribution of a received object to a distributed system having a set of server nodes, the method comprising:
obtaining an identity of the received object;
determining a server node among the set of server nodes to send the object to, based on one or more policies; and
sending the object to the determined server node;
wherein determining the server node comprises:
generating a plurality of candidates using a function that pairs the identity of the object with each of the server node in the set of server nodes;
selecting a candidate that meets the one or more policies among the plurality of candidates, the determined server node corresponding to the server node associated with the selected candidate.

1. (canceled)

2. (canceled)

4. (canceled)

5. (canceled)

6. (canceled)

7. (canceled)

8. (canceled)

9. The method of claim 1, wherein the function is a hash function.

10. (canceled)

11. (canceled)

12. (canceled)

13. (canceled)

14. (canceled)

15. A client node for performing a distribution of a received object to a distributed system having a set of server nodes, the client node comprising:
a network interface;
at least one processor; and
memory comprising instructions executable by the at least one processor, whereby the client node is operable to:
obtain an identity of the received object;
determine a server node among the set of server nodes to send the object to, based on one or more policies; and
send the object to the determined server node;
wherein the client node is operable to determine the server node by:
generating a plurality of candidates using a function that pairs the identity of the object with each of the server node in the set of server nodes;
selecting a candidate that meets the one or more policies among the sorted candidates, the determined server node corresponding to the server node associated with the selected candidate.

16. The client node of claim 15, wherein the at least one processor is configured to obtain the one or more policies.

17. The client node of claim 15, wherein the at least one processor is configured to apply a weight to the plurality of candidates to generate a plurality of weighted candidates.

18. The client node of claim 15, wherein the at least one processor is configured to sort the plurality of candidates.

19. The client node of claim 17, wherein the at least one processor is configured to sort the plurality of weighted candidates.

20. The client node of claim 18, wherein the at least one processor is configured to sort the plurality of candidates associated with the set of server nodes according to one of an ascending order and descending order.

21. The client node of claim 19, wherein the at least one processor is configured to sort the plurality of weighted candidates according to one of an ascending order and descending order.

22. The client node of claim 17, wherein the one or more policies have a higher priority than the weight applied to the plurality of candidates for determining a server node.

23. The client node of claim 15, wherein the function is a hash function.

24. The client node of claim 1, wherein the pairing function is independent from a number of server nodes in the set of server nodes.

25. The client node of claim 15, wherein the candidates in the plurality of candidates are independent from each other.

26. The client node of claim 15, wherein the one or more policies define some criteria that need to be met before a server node is assigned to the object.

27. The client node of claim 15, wherein the client node is a server node.

28. The client node of claim 15, wherein the pairing function is a multi-dimensional function.

29. The client node of claim 17, wherein the at least one processor is configured to apply a weight to the plurality of candidates by applying a multi-dimensional weighting function.

30. The client node of claim 18, wherein the at least one processor is configured to sort the plurality of candidates by applying a multi-dimensional sorting function.

31. The client node of claim 19, wherein the at least one processor is configured to sort the plurality of weighted candidates by applying a multi-dimensional sorting function.

32. (canceled)

33. A non-transitory computer-readable medium comprising instructions executable by at least one processor of a client node for performing a distribution of a received object in a distributed system having a set of server nodes, whereby the client node is operable to:
obtain an identity of the received object;
determine a server node among the set of server nodes to send the object to, based on one or more policies; and
send the object to the determined server node;
wherein the client node is operable to determine the server node by:
generating a plurality of candidates using a function that pairs the identity of the object with each of the server node in the set of server nodes;
selecting a candidate that meets the one or more policies among the sorted candidates, the determined server node corresponding to the server node associated with the selected candidate.
